(19) United States
(12) Patent Application Publication
(10) Pub. No.: US 2007/0217338 A1
(43) Pub. Date: Sep. 20, 2007

(54) Method and apparatus for out-of-band XDSL troubleshooting and testing

(75) Inventors: Jin Wang, Walnut Creek, CA (US); Canhui Ou, Danville, CA (US); Raghvendra G. Savoor, Walnut Creek, CA (US); Steve Sposato, Lafayatte, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/375,510

(22) Filed: Mar. 14, 2006

(51) Int. Cl. H04J 1/16

(52) U.S. Cl. 370/252

(57) ABSTRACT

In one illustrative embodiment a system for maintaining a communication link over a network includes a processor adapted to be coupled to a first communication link, the first communication link connected to a customer premises equipment (CPE), wherein the processor transmits data over the first link and switches to transmit data over the second link in response to a signal that is indicative of a degradation of service over the first link. In one aspect the system may include a switch at a service provider Digital Subscriber Line Access Multiplexer (DSLAM) for switching to a spare pair communication link when a degradation of service signal is received. In another aspect at least one spare pair communication link may be associated with a plurality of primary communication pairs.

### FIELD OF THE DISCLOSURE

The present disclosure relates to communication networks that provide services over data communication links to customer premise equipment.

### DESCRIPTION OF THE RELATED ART

Broadband communication networks provide a variety of network content, including data content from the Internet, voice content using Voice over Internet Protocol (VoIP), and video content over Internet Protocol Television (IPTV), Video-on-Demand (VoD), etc. In one type of network, broadband connections between the network and the users are in the form of Digital Subscriber Line (DSL) connections in which customers access the network using DSL modems over copper lines or optical fibers.

In a typical DSL network, multiple routes are used for sending content from one end of the network to another end so that if one route becomes inoperative, the content can still reach its destination over an alternate route. However, the connection from the customer to the network is typically provided over a single line or link. In such cases, the customer can lose the connection to the network or receive a degraded service when that link experiences a failure.

When an interruption in broadband service occurs, the service provider may not be able to obtain diagnostic data from the residential gateway. A technician is often dispatched to the customer site to obtain the collected data at the residential gateway and to perform tests on the line. Performing diagnostic tests at both the service provider side and the customer side are reliable ways for determining a source of communication degradation in broadband services. However, it is expensive to send a technician to the field in response to problems with broadband services. Thus, there is a need to provide more reliable data links and improved methods for obtaining performance data from customer residential gateways when the links are degraded.

### BRIEF DESCRIPTION OF THE FIGURES

For detailed understanding of the present disclosure, references should be made to the following detailed description of an exemplary embodiment, taken in conjunction with the accompanying drawings:

FIG. 1 illustrates an example of a network system for providing network content to users according to one aspect of the present disclosure;

FIG. 2 illustrates an exemplary communication device for providing network content and communication diagnostic information between a network server and customer premises equipment;

FIG. 3 illustrates an implementation with redundant communication links for living units or a CPE connected with a VDLS cabinet;

FIG. 4 illustrates an implementation with redundant communication links for a group of living units or a CPE connected with a VDLS cabinet;

FIG. 5 illustrates an example of the disclosed embodiment related to alternative communication links for diagnostic information from a CPE;

FIG. 6 illustrates an example of the disclosed embodiment related to peer to peer communication links for diagnostic information from a CPE; and

FIG. 7 is a diagrammatic representation of a machine in the form of a computer system within which a set of instructions, when executed, may cause the machine to perform any one or more of the methodologies discussed herein.

### DETAILED DESCRIPTION OF THE DISCLOSURE

In view of the above, the present disclosure through one or more of its various aspects and/or embodiments is presented to provide one or more advantages, such as those noted below.

The disclosure, in one aspect, provides a computer-readable medium that is accessible to a processor for executing instructions contained in a computer program embedded in the computer readable-medium. The computer program, in one aspect, includes: an instruction to receive data from a communication network over a data communication line; an instruction to interface with a customer premise equipment (CPE) to provide the received data to the CPE; an instruction to store performance data relating to a selected parameter; an instruction to wirelessly establish a connection with a network element via a remote device; and an instruction to transmit the stored performance data to the network element in response to determining the performance data is outside a selected criterion. The computer program may further include an instruction to receive a command from the network element via the remote device, an instruction to take measurements relating to the performance of the data communication line in response to the received command, and an instruction to transmit the measurements to the network element via the remote device. The computer program may further include an instruction to log on to the network element prior to transmitting the stored data and an instruction to establish the connection with the network device utilizing GPRS, UMST, WiMax, Zigbee, or peer-to-peer connection. The remote device may be a DSL modem that is configured to transmit data received from the network element or an element in a wireless network that is adapted to transmit data to the network element. The selected parameter may be bit rate, loop loss, impedance, attenuation, noise spectrum or a function of the DSL modem. The network element may be a central management system that includes one or more servers and data bases to manage performance of DSL lines.

In another aspect, the disclosure provides an apparatus that includes a processor, a computer program accessible to the processor, wherein the processor executes instructions contained in the computer program to receive data from a network (such as a DSL network) over a data communication line; interface with a customer premise device (CPE) for providing the received data to the CPE; collect performance data for at least one selected parameter; establish a wireless connection with a network element via a remote device when the performance data is outside a selected criterion; and transmit the collected performance data to the network element when the performance data is outside a selected criterion. The apparatus further includes a first interface that establishes a connection with the network element over the data communication line and a second interface that provides the received data to the CPE. Additionally, the processor executes instructions to take a measurement relating to performance of the data communication line and transmit the measured data to the network element. In another aspect, the apparatus also includes an adapter that enables the processor to establish a connection with the remote device utilizing any suitable protocol or technique, including GPRS, UMST, WiMax, Zigbee or peer-to-peer connection. The remote device may be a modem, such as a DSL modem located within the wireless reach of the apparatus or a mobile telephone network accessible to the apparatus.

In another aspect, a system is provided that includes a processor coupled to a customer gateway via a data communication line, wherein the processor sends content to the customer gateway over the line, and the customer gateway collects performance data relating to the data communication line and sends the performance data to a network device over a wireless connection if the performance data indicates a degradation of the data communication line. The processor is located at the service provider end and may be a part of a switch, such as a Digital Subscriber Line Access Multiplexer.

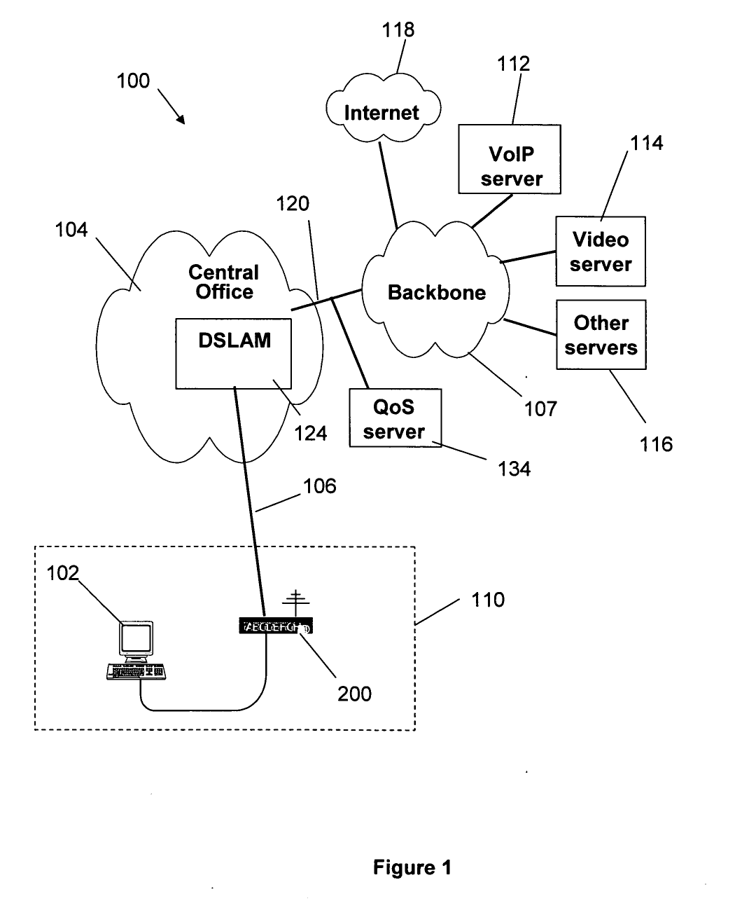

FIG. 1 illustrates an example of a network system 100 for providing network content to customers (users) according to one aspect of the present disclosure. The network system 100 is shown to include a network backbone 107 that includes a variety of servers and transport links that provide network content, such as voice, video and data, using packet-switching technology to one or more central offices or wire centers of the service provider, such a central office 104. The central office 104 include devices, commonly referred to as switches, which may be Digital Subscriber Line Access Multiplexers (DSLAMs), for providing the network content to multiple user locations. A user location, such as location 110, may include one or more customer premises equipment that includes a residential gateway 200, which typically is a DSL modem, and a computer 102. The backbone 107 connects to one or more servers that provide various forms of network content. As an example, the backbone 107 shown in FIG. 1 connects to a Voice over Internet Protocol (VoIP) server 112 for providing voice signal content, a video server 114 for providing video content, and various other servers 116 that provide other network content. The exemplary backbone 107 also is shown connected to the Internet 118 for providing customers access to the Internet.

Network content may be provided from the backbone to the central office 104 over one or more high-speed connections, such as link 120. A network monitoring device, such as Quality of Service server 134, is connected at a suitable location in the network, such as at link 120, and runs an executable program for monitoring performance parameters of various network elements, such as routers, servers, and links of the network system 100. The QoS server 134 may also have a database for storing values of the various parameters. In one aspect, the QoS server may provide a signal to the network that indicates degradation in performance of one or more network elements, such as a reduction in the available bandwidth at a network element, network link, etc. The degradation in performance may be determined by referring, for example, to value of the parameters stored in the database associated with the QoS server.

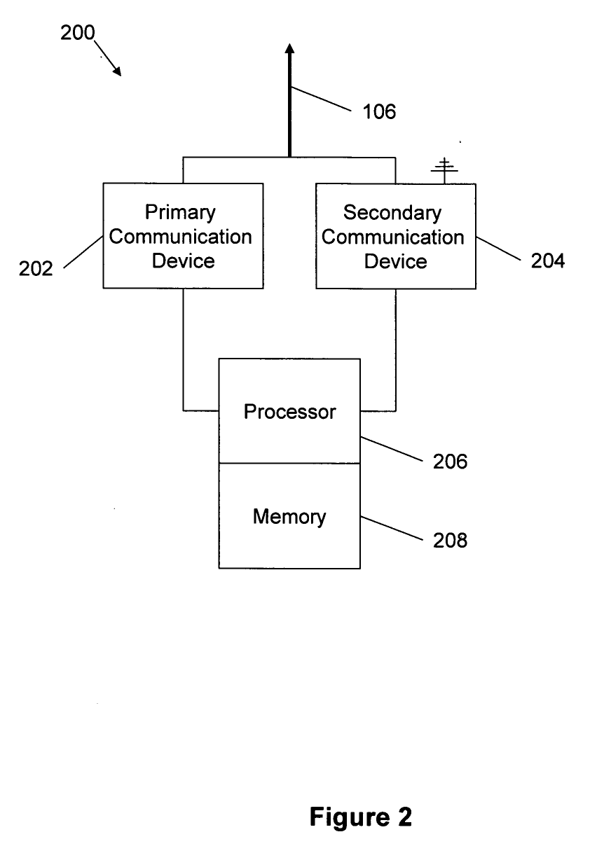

Typically, the broadband network 100 includes at least one user device 102; a Residential Gateway 200 (see FIG. 2) connected to the at least one user device 102; a communication medium 106 connected to the Residential Gateway 200; and a broadband network device 124 at a service provider facility, like a Central Office 104, connected to the user device 102 via a communication medium 106. The network device 124 may be a DSLAM or another suitable device. The user device 102 may be a personal computer, a server, a handheld device, or any other type of device operative to communicate with the network 107. The Residential Gateway 200 may include a xDSL modem, a cable modem, a optical network termination (“ONT”) device, or any other type of communication device capable of linking to the broadband service. Additionally, Residential Gateway 200 may be capable of multiple modes of communication. For example, while Residential Gateway 200 has a main or primary communications device, Residential Gateway 200 may also include a secondary communication device that may include one or more wireless communication modes, including peer-to-peer functionality and/or may include one or more additional wired communication modes.

The Residential Gateway 200, as explained in detail below, may operate in a service mode or a diagnostic surveillance mode (or both). During normal operation in the service mode, the Residential Gateway 200 communicates with a broadband service provider CO 104 via the communication medium 106 to provide a network connection to the user device 200 and/or 102. While operating in the service mode, the Residential Gateway 200 collects data relating to the performance of the communication medium 106 and that of internal elements of the Residential Gateway 200 and stores such information in a memory associated with the Residential Gateway 200 historical data.

If an interruption in the service occurs, such as the Residential Gateway 200 being unable to maintain communications with the broadband service provider CO 104, or the performance of the Residential Gateway 200 falls below a predetermined threshold, the Residential Gateway 200 switches to a surveillance mode. In the surveillance mode, a secondary communication device of the Residential Gateway 200 communicates with the broadband service provider CO 104 to transmit at least a portion of the historical data to the broadband service provider CO 104 for the purpose of determining a source of the interruption in broadband service or a cause of the degraded performance. In the surveillance mode, the Residential Gateway 200 may additionally communicate with the broadband service provider CO 104 via a secondary communication device to coordinate diagnostic tests between the Residential Gateway 200 and the broadband service provider CO 104 to determine a source of the interruption or degradation of communication services.

FIG. 2 is block diagram of one embodiment of a Residential Gateway 200. The Residential Gateway 200 is shown to include a primary communication device 202 operative to communicate with a broadband service provider via data communication link, such a copper pair or optical fiber; a secondary communication device 204 operative to communicate with the broadband service provider via a wireless node, which may be a mobile telephone network or another residential gateway, such a neighbor's residential gateway that is accessible to the Residential Gateway 200; a processor or central processing unit 206 in communication with the primary communication device 202 and the secondary communication device 204; and a memory 208 in communication with the central processing unit 206. Secondary communication device 204 may further include a wireless transceiver for communicating out-of-band information to the Central Office 104.

The central processing unit 206 is operative to switch the Residential Gateway 200 between a service mode and a surveillance mode. Generally, the Residential Gateway 200 operates in the service mode during normal communication between the primary communication device 202 and a broadband service provider, and operates in the surveillance mode when there is an interruption in the service or the performance over the primary communication device 202 is degraded or falls below a predetermined threshold. The performance threshold may be any value set by the broadband service provider that is characteristic of unsatisfactory service. During operation in the service mode, the central processing unit 206 activates the primary communication device 202 so that the primary communication device 202 may communicate with the service provider.

During communication between the primary communication device 202 and the broadband service provider, the central processing unit 206 monitors performance of the communication line and the primary communication device 202 stores such information as historical information in the memory unit 208. The historical information may include measurements relating to any number of parameters relating to the line and the device 202 itself. Such measurements may include, loop loss, insertion loss, noise, impedance, attenuation, bit rates (upstream and downstream) and other various performance parameters such as signal-to-noise ratio, maximum attainable bit rate, noise margin and code violations and any other information relating to the performance of the line and the communication device 202.

The central processing unit 206 may be directed to arbitrarily switch the Residential Gateway 200 from the service mode to the surveillance mode. While operating in surveillance mode, the central processing unit 206 may activate the secondary communication device 204. The secondary communication device 204 may be a voice-band modem; a wireless modem that operates over general packet radio service (“GPRS”), Zigbee, wireless fidelity (“WiFi”), WiMax, or any other wireless protocol or another suitable protocol. Thus, the device 200 can communicate with an element in the communications network. A network element may be a DSLAM or a Central Management System or another selected device by wirelessly establishing a connection with such network element when a service provided over the link 106 degrades or a particular performance parameter is below a threshold or a selected value.

In another embodiment, the secondary communication device 204 may communicate with the network element of the service provider to automatically run diagnostic tests, wherein the Residential Gateway 200 acts as a test device for the line at the customer end and a network device, such as an electrical test device or DSLAM acts as test device at the service provider end. The diagnostic tests determine historical data that may be used to determine the source of the problem. For example, if the primary communication device 202 is an xDSL modem, the secondary communication device 204 may communicate with a broadband service provider to perform double-ended loop tests such as measurements for loss and noise which require coordination between the primary communication device 202 and the broadband service provider. In one test, the central processing unit 206 may coordinate with the broadband service provider to output one or more test tones in a selected xDSL frequency band with a fixed power. In response, the broadband service provider measures the power of the received test tones to determine what power loss exists between the Residential Gateway 200 and the service provider. In another test, the Residential Gateway 200 may measure a noise spectrum in the DSL band and then transfer the test data back to the service provider via the secondary communication device 204. In yet another test, the Residential Gateway 200 may conduct a time-domain reflectometry (TDR) measurement and then transfer the TDR waveform back to the service provider via the secondary communication device 204. Using the data from these tests, the service provider may be able to determine the source of an interruption and automatically suggest a solution to the customer to alleviate the interruption in the service.

In yet another embodiment, the secondary communication device 204 may be used to perform diagnostic tests that the primary communication device 202 is not designed to perform, such as bridged taps. A bridged tap may be an unused cable pair connected at an intermediate point or an extension of the circuit beyond the service user's location. A bridged tap creates an impedance mismatch within the transmission line, which creates signal reflections. These reflections are generally not noticed in POTS communications, but become significant with high frequency xDSL services. For example, in one test, the central processing unit 206 may direct the primary communication device 202 to take a loss spectrum measurement. If the loss spectrum reveals a bridged tap that impairs performance, the central processing unit 206 may then direct the secondary communication device 204 to conduct a TDR measurement to determine at which end of the line the tap-impairing performance is located.

In another embodiment, the secondary communication device 204 may additionally be used to communicate with an Internet Service Provider to provide Internet service to the Residential Gateway 200 whether or not the primary communication device 202 communicates with the broadband service provider. For example, if the primary communication device 202 is a DSL modem, cable modem, or ONT, and a disruption or degradation in broadband service occurs, the Residential Gateway 200 may use the secondary communication device 204 to provide Internet service to the Residential Gateway 200.

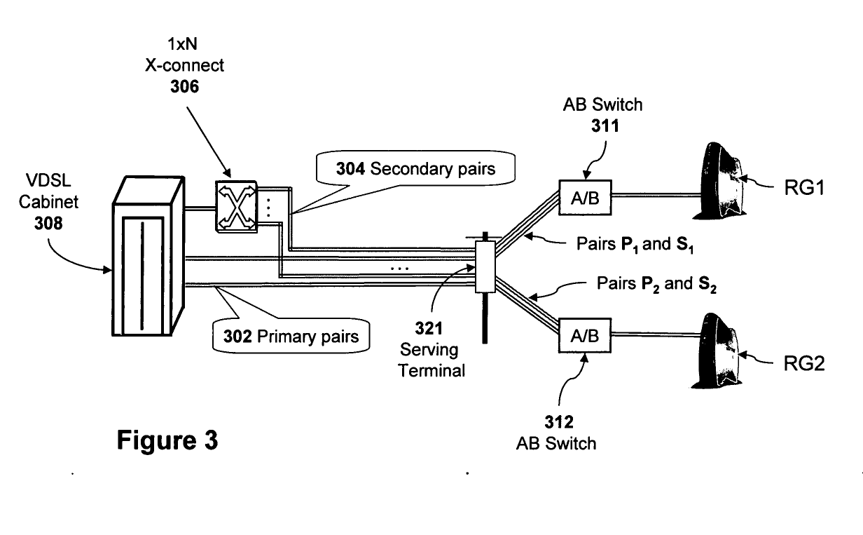

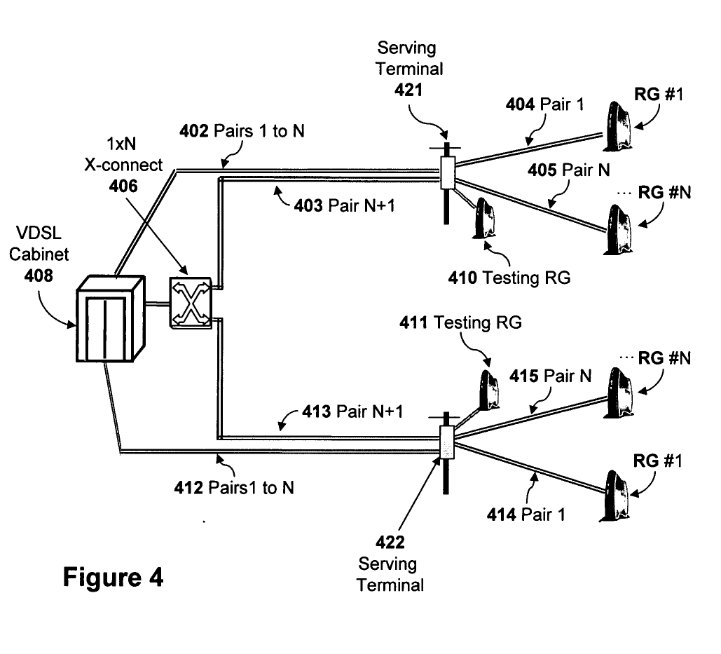

A physical layer diagnostic embodiment for out-of-band interfaces implemented from the ISP side is illustrated in FIG. 3 and includes implementation of two VDSL capable pairs per living unit or CPE in communication with a VDLS cabinet. A VDSL cabinet may be a DSLAM associated with a CO. Alternatively, as illustrated in FIG. 4, one spare VDSL pair for testing per Serving Terminal may serve to provide redundancy to a group of Residential Gateways connected by way of the Serving Terminal. Also, a Wideband Test Head may be associated with an SAI and the testing capability may be integrated into a DSL Line Card at the DSLAM.

FIG. 3 illustrates an embodiment to provision two VDSL capable pairs (Primary pairs 302 and Secondary pairs 304) associated with end-user residential gateways RG (i.e., redundant pairs may be provided for every living unit). The pairs are arbitrarily labeled as “primary” and “secondary.” Under normal circumstance, primary pairs (P₁ and P₂ in this example) are used for VDSL transmission and the secondary pairs (S₁ and S₂) are connected to the DSLAM (i.e., VDSL cabinet) 308 through an electronic 1×N cross-connect 306. The primary and secondary pairs may pass through a Serving Terminal 321 that may include optional switching between primary and secondary pairs, which enables continuity and other diagnostic analysis from the ISP side. The switching between the primary and secondary pairs at the Service Terminal may be activated from the service provider end, such as via the VDSL cabinet or another server or may be activated according to programmed instructions associated with the service Terminal upon the occurrence of a degradation event. At the customer premise an A/B switch 311 or 312 may be used to connect either the primary pair or the secondary pair to the customer (whether RG1 or RG2). The FIG. 3 embodiment includes a port associated with the VDSL cabinet that may be dedicated to testing any of the pairs. The cross-connect 306 may enable the assignment of a test port for any pair being tested. The A/B switch may be a part of or substantially adjacent to the RG. FIG. 3 enables real time double-ended remote line testing to a customer RG. The redundant pair lowers the mean time to repair (MTTR) and isolation of pair-specific faults. During the occurrence of a service outage or degradation, the secondary pairs 304 will be chosen for VDSL transmission by switching the 1×N cross-connect 306 and with substantially contemporaneous toggling the A/B switch(es) 311 or 312 as or if required. After the VDSL service is switched from a primary pair to a second pair, the technician may then be dispatched to troubleshoot the primary pair and make any repairs.

FIG. 4 illustrates an embodiment that includes a spare or redundant communication link per group of N subscribers. The spare link serves as a secondary pair available for any line in the associated group. In this configuration, a VDSL cabinet 408 is connected by N pairs of wires, Pairs 1 to N 402 to a Serving Terminal 421 and then on to an RG for each of the N end-users in the group of subscribers, from Pair 1 404 to RG#1 through Pair N 405 to RG#N. As shown, a VDSL cabinet may support more than one group of N Subscribers, for example by Pairs 1 to N 412 to Serving Terminal 422 and on to Pair 1 414 through Pair N 415. As shown in FIG. 4, every N VDSL pairs are assigned one backup pair, i.e., pair N+1 403 or 413. When all N pairs are working normally, the pair N+1 403 (or 413) is connected to VDSL cabinet through a 1×N cross-connect 406 associated with VDSL Cabinet 408. In one aspect, a test RG or a VDSL RG for testing 410 (or 411) associated with pair N+1 403 (or 413) is provided that is used to monitor the spare pair so as to ensure its VDSL capability. Examples of RGs for testing include a Line powered VTU-R (a remote VDSL transceiver unit) and a Sleep Mode DC Powered VTU-R. Once a VDSL communication pair in the group from 1 to N 402 develops a fault or communication degradation between the VDSL Cabinet 408 and an RG associated with Pairs 1 to N, the backup Pair N+1 403 will be used to provide the service for affected line by cross-connecting the backup pair at the Serving Terminal 421. The service switching from a VDSL pair to the backup pair ensures continued service as the backup pair is VDSL ready. The VDSL pair being replaced may be connected to cross-connect 406. For the embodiment of FIG. 4, similarly as with FIG. 3, there may be redundant primary and secondary pairs from Serving Terminal 421 to a CPE switch associated with the RGs (e.g., 311, 312 or equivalent switches).

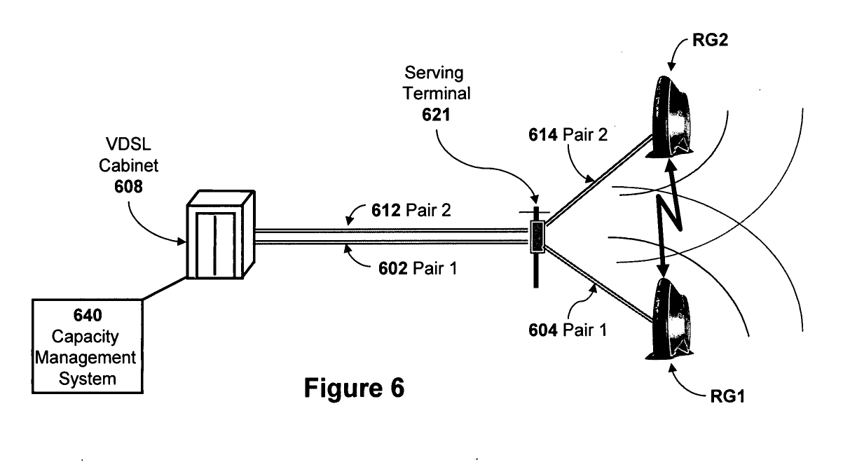

After the VDSL service is switched from the faulty pair to the pair N+1, the technician may then be dispatched to troubleshoot the faulty pair and fix it. During the troubleshooting time, the customer is able to keep enjoying the VDSL service. The embodiment illustrated in FIG. 6 enables real-time double-ended line testing the serving terminals and verification of Layer 1 to 3 functions. Problems are more quickly isolated as being related to a drop or an RG.

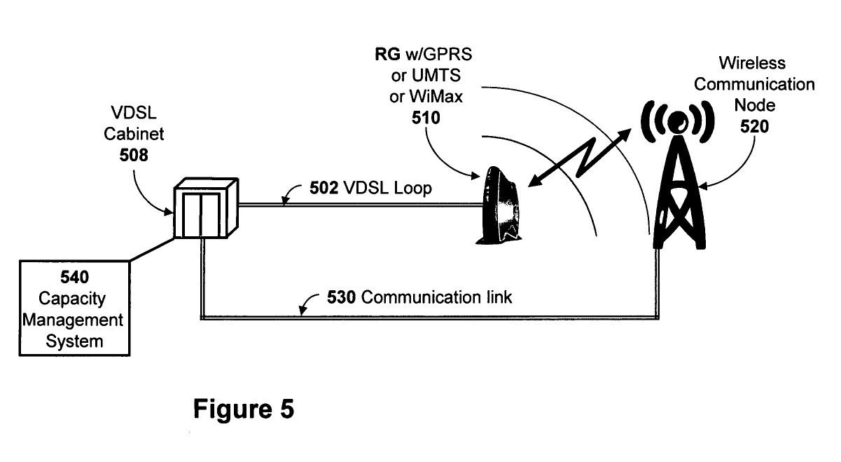

FIG. 5 illustrates an embodiment that includes built-in GPRS/UMTS adaptors at RGs. This embodiment provides enhanced loop diagnostic function capabilities, which aids in minimizing technician dispatch time.

The General Packet Radio Service (GPRS) is a non-voice value-added service that allows information to be sent and received across a mobile telephone network. The Universal Mobile Telecommunications System (UMTS) is a 3G mobile technology that delivers broadband information at speeds up to 2 Mbit s/sec. A current implementation for many service providers is GPRS and for others is UMTS.

When VDSL service from a VDSL cabinet 508 over a VDSL communication link 502 is degraded or disrupted due to cable faults or an RG internal fault, the RG may automatically activate a GPRS/UMTS service to log into a control center, which may be a Capacity Management System (CMS) 540 that may be associated with cabinet 508 or other CO associated facility through a wireless connection between RG 510 and wireless node 520. Thus, the RG may automatically connect by way of a wireless session linked to a CMS when the in-band connection fails.

A proxy server associated with the CMS may support autonomous client login when the primary or in-band communication link is degraded. The CMS can retrieve the historical data on VDSL service or VDSL loop which have been stored in the internal memory of the RG when it was working properly.

In many cases, the historical data would exhibit the degradation of VDSL service with time and tend to aid the diagnosis for the current trouble. Furthermore, via the wireless connection, a test head associated with CMS 540 that may be located at VDSL cabinet 508 may control the RG 510 by way of link 530 to 520 to 510 to perform double-ended loop tests such as wideband loss and noise measurement. For example, following the commands received through the combination of wireless or wired connections, the RG outputs a few tones in VDSL band with a fixed power and the test head measures the received power at VDSL cabinet, thus, loop loss is obtained. As another example, the RG can measure the noise spectrum in VDSL band and transfer the acquired data back to the test head via wireless communication node 520. Thus, the noise condition at the RG 510 end is obtained. In essence, the test head (CMS 540) and the RG 510 include an automatic VDSL loop troubleshooting system.

In addition to GPRS and UMTS, the RG 510 may also use WiMax (Worldwide Interoperability for Microwave Access) to transfer information back to a control center (508/540). WiMAX is a standards-based wireless technology that provides high-throughput broadband connections over long distances. WiMAX may be used for a number of applications, including “last mile” broadband connections, hotspots and cellular backhaul, and high-speed enterprise connectivity for business. The principle is the same whether using GPRS, UMTS, Zigbee peering or WiMax and the differences are in the wireless band, communication protocol and connection speed.

FIG. 6 illustrates yet another embodiment wherein wireless connections may based (as in FIG. 5) on Wi-Fi, Zigbee or any other peer-to-peer wireless protocol. However, this embodiment includes “Wi-Fi Peering” so that data and diagnostic information and requests may be transmitted over available wireless links when a primary link drops out. When VDSL service is working normally, residential gateways do not interact with each other. However, once a VDSL customer is out of service, for example the customer on Pair 1 (602 and/or 604), then the RG1 begins to search for any nearby residential gateway. When RG1 finds RG2 over a wireless connection, then RG1 may log into a control center through the communication link to a CO or other control center type facility provided by RG2. Through the VDSL connection on Pair 2 (612 and/or 614) and the wireless connection between RG2 and RG1, the control center can retrieve the historical data on VDSL service and loop condition from RG1 so as to troubleshoot Pair 1 (along 602 and 604). Moreover, via the Wireless peer-to-peer connection, a test head located at VDSL cabinet (or other control center facility) can control RG1 to perform double-ended loop tests such as wideband loss and noise measurement.

When this Wi-Fi Peering capability is combined with the communication link switching, a Capacity Management System 640, the communication linking redundancy aspects and diagnostic aspects illustrated with respect to FIG. 3, FIG. 4 and FIG. 5, the overall combination is a powerful and rapid troubleshooting and service restoration system. This embodiment further leverages the redundant configurations of FIG. 3 and FIG. 4. In another aspect a customer may administer WAP change and defaults SSID of the RG to a pre-set “test” setting. In still another aspect a Test VTU-R associated with a Serving Terminal may connect to an RG associated with a primary communication link failure. In still yet another aspect, telnet or ftp agents may “tunnel” in to the RG to obtain data and run tests.

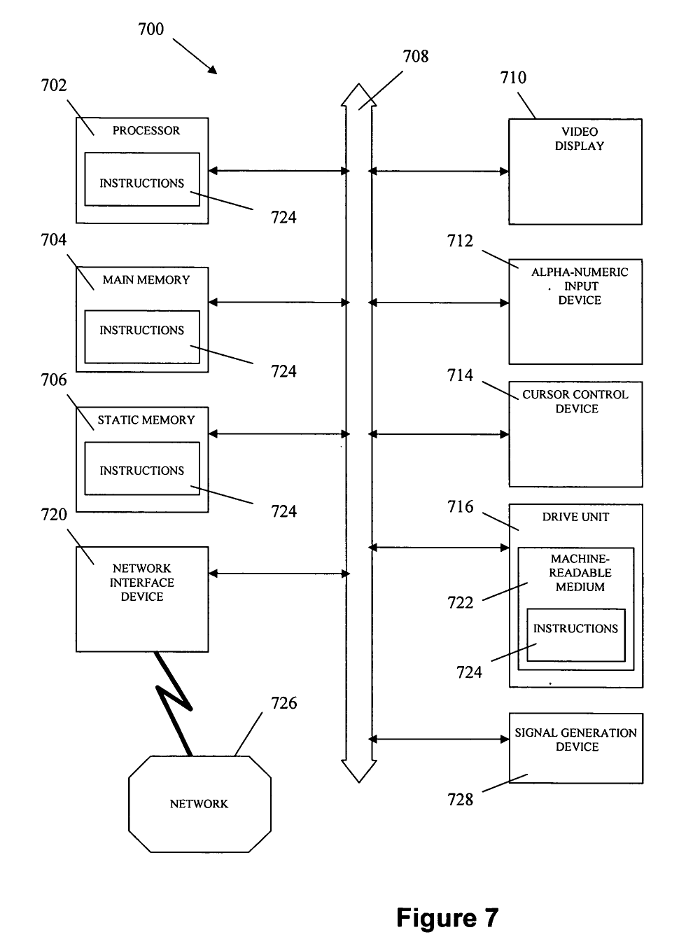

FIG. 7 is a diagrammatic representation of a machine in the form of a computer system 700 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may include a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 916 may include a machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 706, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-readable medium accessible to a processor for executing instructions contained in a computer program embedded in the computer readable-medium, the computer program comprising:
an instruction to receive data from a network over a data communication line;
an instruction to interface with a customer premise equipment (CPE) to provide the received data to the CPE;
an instruction to store performance data relating to a selected parameter;
an instruction to wirelessly establish a connection with a remote device; and
an instruction to transmit the stored performance data to a network element via the remote device in response to detecting that the performance data of the selected parameter is outside a selected criterion.

2. The computer-readable medium of claim 1, wherein the computer program further comprises:
an instruction to receive a command from the network element via the remote device;
an instruction to take a measurement relating to performance of the data communication line in response to the received command; and
an instruction to transmit the measurement to the network element.

3. The computer-readable medium of claim 1, wherein the computer program further comprises:
an instruction to log on to the network element prior to transmitting the stored data.

4. The computer-readable medium of claim 1, wherein the computer program further includes an instruction to establish the connection with the network device utilizing one of: GPRS; UMST; WiMax; Zigbee; and peer-to-peer connection.

5. The computer-readable medium of claim 1, wherein the remote device is one of:
a modem adapted to transmit data to the network element; and an element in a wireless network that is adapted to transmit data to the network element.

6. The computer-readable medium of claim 1, wherein the selected parameter includes at least one of: bit rate; loop loss; impedance; attenuation; a noise spectrum.

7. An apparatus, comprising:
a processor;
a computer program embedded in a computer-readable medium accessible to the processor, the processor executing instructions contained in the computer program to:
receive data from a network over a data communication line;
interface with a customer premise device (CPE) for providing the received data to the CPE;
collect performance data for at least one selected parameter;
establish a wireless connection with a network element via a remote device; and
transmit the collected performance data to the network element in response to determining that the performance data is outside a selected criterion.

8. The apparatus of claim 7, wherein the processor further executes instructions to log on to the network element device prior to transmitting the collected performance data.

9. The apparatus of claim 8 further comprising:
a first interface that establishes a connection with the network element over the data communication line; and
a second interface that provides the received data to the CPE.

10. The apparatus of claim 7, wherein the processor establishes a two-way data communication between the CPE and the network element.

11. The apparatus of claim 7, wherein the processor further executes instructions to:
receive a command from the network element;
take a measurement relating to performance of the data communication line in response to the received command; and
transmit the measurement to the network element.

12. The apparatus of claim 7 further comprising an adapter that enables the processor to establish a connection with the remote device utilizing one of: GPRS; UMST; WiMax; Zigbee; and peer-to-peer connection.

13. The apparatus of claim 7, wherein the remote device is one of: a DSL modem adapted to transmit the performance data to the network element; and an element in a wireless network that is adapted to transmit the performance data to the network element.

14. The apparatus of claim 7, wherein the parameter includes at least one of: bit rate, loop loss, impedance, attenuation; noise spectrum; and a function of an element of the apparatus.

15. The apparatus of claim 7, wherein the data communication line is one of a twisted copper pair, and an optical fiber.

16. A method of providing content from a network to a customer gateway, comprising:
sending data from a network element to the customer gateway over a first line via a cross-connect coupled to the customer gateway;
sending test data between the network element and a test device over a second line coupled to the cross-connect; and
connecting the second line to the customer gateway at the cross-connect in response to determining that the performance of the first line is degraded and the test data indicates that performance of the second line meets a selected criterion.

17. The method of claim 16, wherein the network element includes a processor that sends the data over the first line, the method further comprising connecting the second line to the processor.

18. The method of claim 16 further comprising performing a double-ended test on the second line utilizing the test-device.

19. A system, comprising:
a processor coupled to a customer gateway via a data communication line, wherein:
the processor sends content to the customer gateway over the line; and
the customer gateway collects performance data relating to the data communication line and sends the performance data to a network device over a wireless connection in response to determining that the performance data indicates a degradation of the data communication line.

20. The system of claim 1, wherein the processor is a component of a Digital Subscriber Line Access Multiplexer.

21. The system of claim 19, wherein the network element includes a server that determines performance of the data communication line from the collected performance data.

22. The system of claim 21, wherein the customer gateway logs on to the network element before sending the performance data.
